(19) United States
(12) Patent Application Publication
(10) Pub. No.: US 2004/0233113 A1
(43) Pub. Date: Nov. 25, 2004

(54) Multi band low frequency phone and antenna design

(76) Inventors: Laurent Desclos, San Diego, CA (US); Gilda Fathi, Encinitas, CA (US); Sebastian Rowson, San Diego, CA (US)

Correspondence Address: Mark Wardas, POB 2192, La Jolla, CA, 92038, US

(21) Appl. No.: 10/624,668

(22) Filed: Jul. 22, 2003

Related U.S. Application Data
(60) Provisional application No. 60/473,253, filed on May 24, 2003.

(51) Int. Cl. H01Q 1/24; H01Q 1/36

(52) U.S. Cl. 343/702; 343/895

(57) ABSTRACT

A parasitic element when excited couples to a primary antenna of a phone to enable multi band low frequency phone operation.

### RELATED APPLICATIONS

The present Application claims priority from commonly assigned U.S. Provisional Application S. No. 60/473,253, filed on May 24, 2003.

The present Application incorporates by reference commonly assigned U.S. patent application Ser. No. 10/375,423, filed on Feb. 27, 2003.

### FIELD OF THE INVENTION

The present invention relates generally to low frequency antenna design for communication devices and more particularly to multi band low frequency antenna design for cell phones.

### BACKGROUND

The design of low frequency dual band internal antennas for use in modem cell phones poses many challenges. Standard technologies require that antennas be made larger when operated at lower frequencies. With present cell phone designs leading to smaller and smaller form factors, it becomes more difficult to design internal antennas for low frequency applications. The present invention addresses deficiencies of prior art antenna designs.

### SUMMARY OF INVENTION

One or more parasitic resonator elements, as further described herein, are used to create secondary resonances in a primary antenna. Because only one relatively large primary antenna is required, more antenna “real estate” is available for phone design, whether it be a reduction of phone size, larger phone display, etc.

In one embodiment, a multi band communications device comprises a primary antenna, the primary antenna for enabling a frequency at which the communications device operates; and a resonator element, wherein an excited resonator element couples with the primary antenna to alter the frequency at which the communications device operates. The primary antenna may comprise a low frequency antenna. The low frequency may be within the 300 to 500 MHz frequency band. The primary antenna may comprise a coil antenna. The radiation pattern of the primary antenna may comprise a dipole type radiation pattern. The radiation pattern of the resonator element may comprise a quadruple type radiation pattern. The resonator element may comprise a spiral geometry. The resonator element may comprise a dipole geometry. The communications device may comprise a housing, wherein the resonator element is disposed within the housing of the communications device. The communications device may operate at two or more low frequencies. The communications device may comprise a stub antenna, wherein only the primary antenna comprises a stub antenna. The communications device may comprise a phone. The communications device may comprise a PDA type device.

In one embodiment, a phone for operating at a frequency may comprise a plurality of resonator elements, wherein one excited resonator element couples with another resonator element to effectuate the operating frequency at which the phone operates. One of the plurality of resonator elements may radiate with a dipole radiation pattern. At least one other of the plurality of resonator elements may radiate with a quadruple radiation pattern. At least one of the plurality of resonator elements may comprise a parasitic resonator. The phone may comprise a multi band low frequency phone, wherein the phone comprises a housing, and wherein at least one of the plurality of resonator elements is coupled to the housing. The multi band low frequency phone may comprise only one stub antenna. The frequency may be in a range below or above 1 GHz.

In one embodiment, a resonator for use with a primary antenna in a phone comprises a parasitic element, wherein when excited a parasitic element couples with the primary antenna to change an operating characteristic of the primary antenna. The parasitic element when excited exhibits a quadruple type of radiation pattern. The primary antenna may comprise a stub type antenna.

In one embodiment, a resonator for use with a primary antenna in a phone may comprise parasitic coupling means for parasitically coupling to the primary antenna so as to change an operating characteristic of the primary antenna.

In one embodiment, a method of using a parasitic resonator in a communications device may comprise the steps of: providing a primary antenna that exhibits a radiation pattern when excited; providing a parasitic resonator that comprises a radiation pattern when excited; positioning the parasitic element such that when excited it electronically couples to the primary antenna so as to change an operating characteristic of the primary antenna. The communications device may comprise a phone. The communications device may comprise a PDA. The primary antenna may comprise a stub type antenna. The communications device utilizes only one stub type antenna. The operating characteristic may comprise an operating frequency that is less than 1 GHz.

Other embodiments are within the scope of the claimed invention and will become apparent from the descriptions provided herein.

### FIGURES

FIG. 1 illustrates a single low frequency band prior art phone;

FIG. 2 illustrates a multi band low frequency prior art phone;

FIG. 3a illustrates a phone designed to be operated at a primary low frequency F1 and one or more other low frequency;

FIG. 3b illustrates one embodiment of a primary resonator;

FIG. 3c illustrates a radiation pattern of a primary resonator;

FIG. 3d illustrates one embodiment of a parasitic resonator element;

FIG. 3e illustrates a radiation pattern of a parasitic resonator element;

FIG. 3f illustrates the radiation patterns of a primary antenna and a parasitic resonator element positioned to achieve placement of a lobe of the radiation pattern of the resonator element between lobes of the radiation pattern of the primary antenna;

FIG. 3g illustrates one of many possible geometrical orientations between a primary antenna and a resonator element;

FIG. 4 illustrates the frequency response of a primary antenna as affected by the coupling effects of six parasitic resonator elements;

FIG. 5a illustrates an embodiment wherein two parasitic resonator elements and a primary antenna are connected to a substrate of a multi band low frequency prior art phone; and

FIG. 5b illustrates a return loss graph of a primary antenna as affected by two parasitic resonator elements.

### DETAILED DESCRIPTION

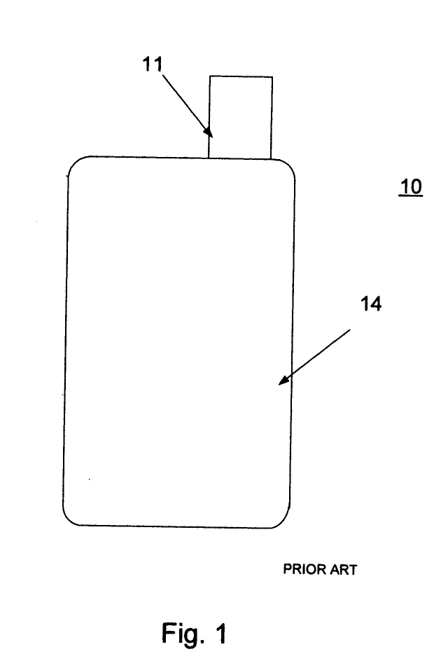

FIG. 1 illustrates a low frequency single band prior art phone (10). In FIG. 1, prior art phone (10) is shown to include one low frequency stub type antenna (11) extending from a phone housing (14). Those skilled in the art will understand the principles used to effectuate operation of phone (10) and stub antenna (11) at only one low frequency, for example, at 450 MHz. Those skilled in the art will also recognize that when used with a portable communications device, for example, a cell phone, operation of the stub antenna (11) at a single low frequency would require that the antenna comprise dimensions that are relatively large compared to the size of the phone housing (14).

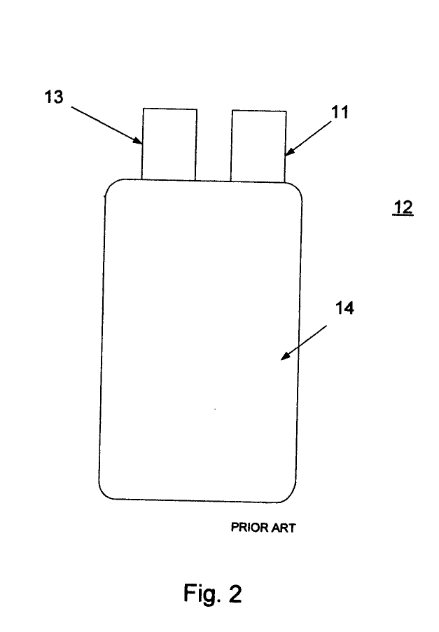

FIG. 2 illustrates a multi band low frequency prior art phone (12). In FIG. 2, prior art phone (12) is shown to include two or more low frequency stub type antennas (11) and (13) extending from a phone housing (14). Those skilled in the art will understand the principles used to effectuate operation of phone (12) and stub antennas (11) and (13) at two low frequencies, for example, at 430 and 450 MHz. Those skilled in the art will also recognize that design of cell phone (12) for use with two or more low frequency stub antennas would require that the phone housing (14) be able to accommodate the relatively large size of the antennas. With the cell phone designer's desire for an ever decreasing phone size, design of cell phones for use with two or more relatively large antennas poses an increasingly difficult challenge.

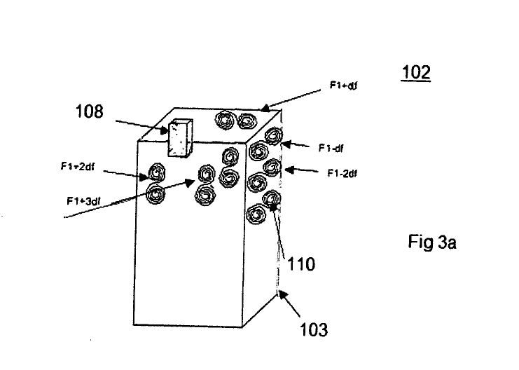

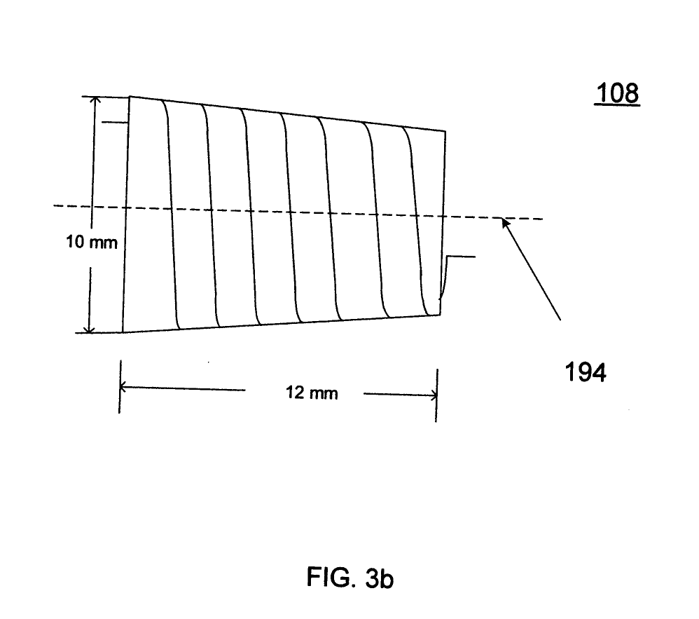

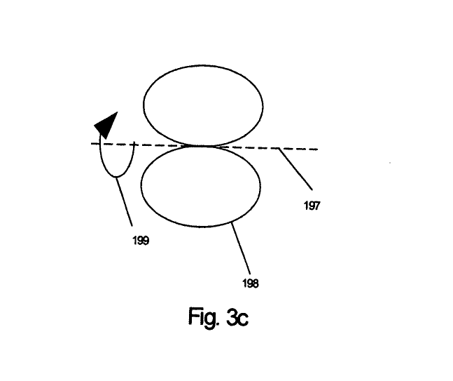

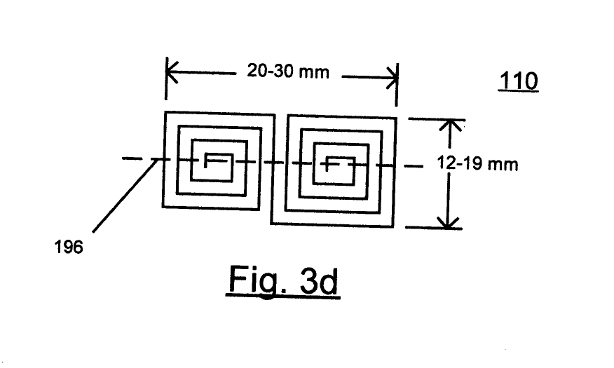

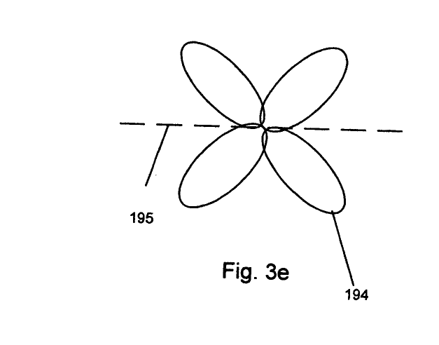

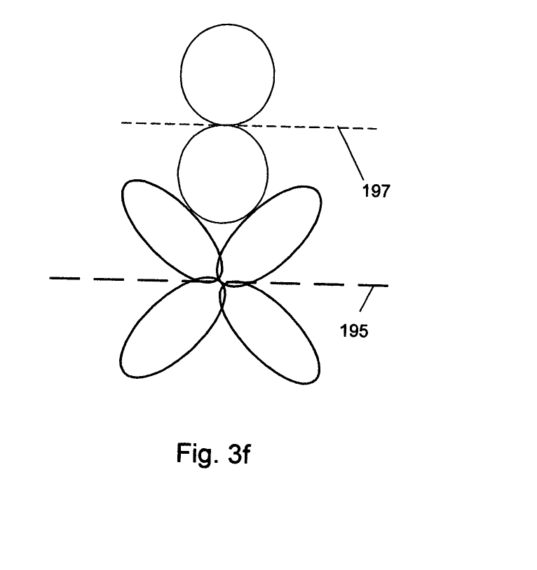

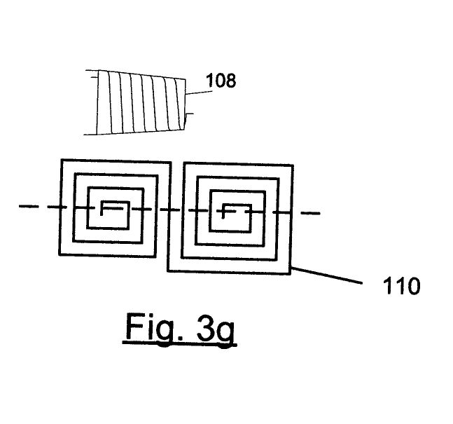

FIGS. 3a-g illustrate characteristics of a multi band low frequency phone (102) designed in accordance with one or more of the principles described below. In FIG. 3a there is shown one embodiment of a phone (102) designed to be operated at a primary low frequency F1 and one or more other low frequency. In one embodiment, phone (102) comprises a cell phone, PDA, or other communications device. Phone (102) includes a housing (103), a primary resonator element (108) designed to resonate at a primary frequency F1, and one or more parasitic resonator element (110) designed to resonate at a frequency different from that of the primary resonator element (108).

FIG. 3b illustrates one embodiment of a primary resonator element (108). In one embodiment, primary resonator element (108) comprises a stub type antenna concentrically centered about an axis (194). In one embodiment, antenna (108) is designed to effectuate a dipole type radiation pattern, for example, as is illustrated by FIG. 3c. In the illustrative embodiment of FIG. 3c, an axis (197) of the dipole radiation pattern corresponds to the centrally located axis (194) of antenna (108).

In the illustrative embodiment of FIG. 3c, although only a cross-section in one plane of the dipole radiation pattern (198) of antenna (108) is shown, in actual operation, the radiation pattern extends about the axis (197) in a direction (199), and similarly about the centrally located axis of antenna (108). The geometries illustrated in FIG. 3b are illustrative of one embodiment and are not meant to be limiting of the present invention. Thus, it is understood that in other embodiments, by utilizing well known principles understood by those skilled in the art, primary antenna (108) may comprise other geometries that effectuate operation of phone (102) at other low frequencies and with other radiation patterns.

In one embodiment, the one or more parasitic resonator element (110) of FIG. 3f comprises a geometry designed such that when a resonance mode of the resonator element is excited, the radiation pattern of the one or more resonator element (110) couples to the radiation pattern of the primary antenna (108).

In one embodiment, one or more parasitic resonator element (110) may comprise a spiral shaped geometry, for example as illustrated in FIG. 3d. The geometries and dimensions illustrated in FIG. 3d are illustrative only and are not meant to be limiting of the present invention. It is understood that in other embodiments, by utilizing well known principles understood by those skilled in the art, parasitic resonator element (110) may comprise other geometries and dimensions to effectuate operation of phone (102) at other low frequencies and with other radiation patterns. In one embodiment, parasitic resonator element (110) comprises a conductor, for example, copper or the like. In one embodiment, resonator element (110) may be formed on a substrate, for example, by the deposition of conductive traces on the substrate. In one embodiment, one or more parasitic resonator element (110) is designed to effectuate a quadruple type radiation pattern as illustrated by FIG. 3e.

In the illustrative embodiment of FIG. 3e, a major axis (195) about which the radiation pattern of a resonator element (110) is centered, corresponds to a major axis (196) of the resonator element (110). One advantage that derives from using a resonator element (110) shaped in the form of a spiral is that its resonant frequency can be adjusted easily without large concomitant changes in geometry. For example, by reducing the gap between the spiral traces of a resonator element (110) and by increasing the number of turns in the spiral, the resonant frequency of the resonator element may be changed. It is also identified that the geometry of the radiation pattern of a spiral resonator element (110) is such that it may be positioned to overlap the radiation pattern of antenna (108) in a manner that permits beneficial reduction of the distance between the antenna (108) and resonator element (110), and such that a small phone may accommodate a primary antenna (108) and resonator element (110) combination. It is further identified that an antenna (108) and resonator element (108) combination described herein obviates the need for a bulky second antenna, for example, a second stub type antenna as is used in the prior art.

In FIG. 3f it is identified that appropriate positioning of a primary antenna (108) and resonator element (110) may be used to achieve placement of a lobe of the radiation pattern of the resonator element (110) to overlap lobes of the radiation pattern of the primary antenna (108). It is identified that such positioning may be used to reduce the distance needed to parasitically couple resonator element (110) to primary antenna (108) in the near field. Such a method of coupling in the near field may be used to optimize overall return loss and efficiency of the antenna (108) without affecting the omni-directional far field pattern, which can be smoothed by diffraction of the shape of a cell phone housing.

FIG. 3g illustrates one of many possible geometrical orientations of a primary antenna (108) and a resonator element (110) that may be used to effectuate operation of a phone at two low frequencies. In one embodiment, optimal coupling between primary antenna (108) and resonator element (110) may be achieved by disposing resonator element (110) approximately 6 mm from the antenna (108). In one embodiment, the central axis of a primary antenna (108) may be disposed generally parallel to the central axis of a resonator element (110). In one embodiment, the central axis of a primary antenna (108) may be disposed generally perpendicular to the central axis of a resonator element (110). Other angular orientations and other distances that achieve optimal coupling between a primary antenna (108) and one or more resonator to element (110) are possible and within the scope of the invention and would be understood by those skilled in the art. Those skilled in the art will also understand that the positioning that achieves optimal coupling may be affected by placement of shields and other metallic components and may, thus, vary from one design to another design.

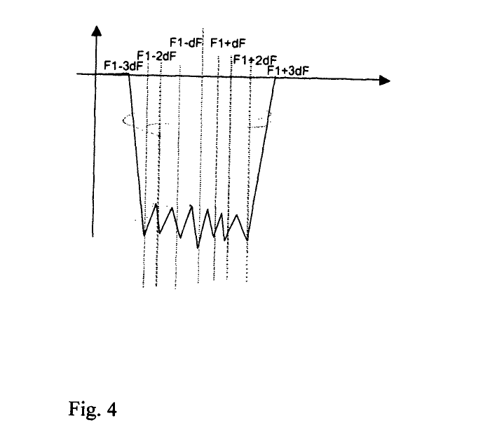

FIG. 4 illustrates the frequency response of a primary antenna (108), as affected by the coupling effects of six parasitic resonator elements. In one embodiment, the resonance mode of each of six resonator elements (110) comprises a frequency that differs from the primary frequency F1 of antenna (108) by a multiple of df, for example, by F1−3df, F1−2df, F1−df, F1+df, F1+2df, and F1+3df It is identified that the effect of coupling one or more parasitic element may be used to increase the number of frequencies and/or the bandwidth over which the primary antenna (108) of a phone (102) may operate. As illustrated by FIG. 4, in one embodiment that utilizes six parasitic resonator elements (110), the frequency over which antenna (108) operates is envisioned to be increased by+/−3df. It is identified that such multiple band operation of a primary antenna (110) may be, thus, achieved without the need for more than one relatively large low frequency antenna.

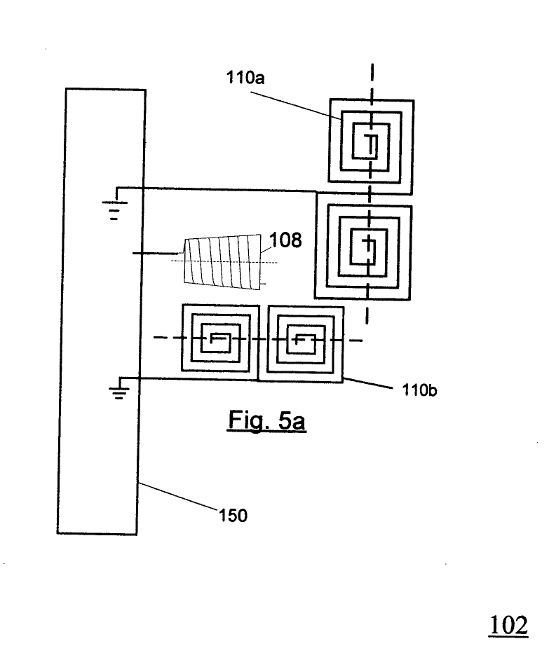

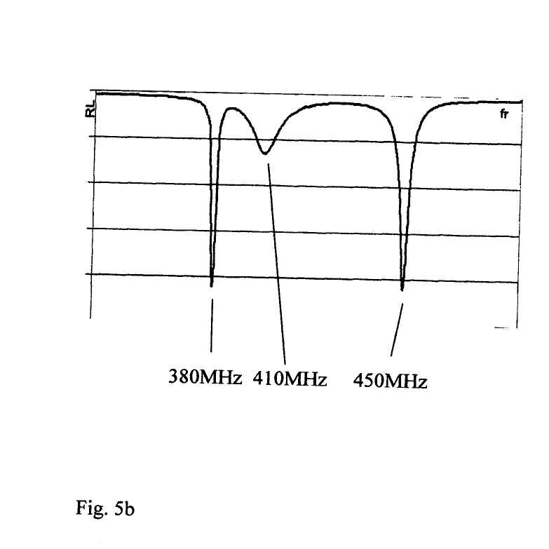

FIG. 5a illustrates a primary resonator (108) and two parasitic resonator elements (110a-b) electrically connected to one or more circuit of a phone (102). In one embodiment, spiral parasitic resonator elements (110a-b) are coupled to ground connections at a substrate (150), and the primary resonator (108) is coupled at one end to an antenna feed connection at the substrate (150). In one embodiment, primary resonator (108) comprises a 450 MHz helical coil antenna designed to conform to a to 10 mm stub shaped housing with a pitch of 1.4 mm and with 5.5 turns, and resonator elements (110a-b) comprise geometries designed to create two different resonances at which a primary resonator (108) operates, for example at 380 and 410 MHz.

FIG. 5b illustrates a return loss graph of a primary resonator (108), 15 wherein two of the three illustrated return loss minima (corresponding to primary resonator (108) operating frequencies 380 MHz, 410 MHz, 450 MHz) are effectuated by the parasitic coupling of resonator elements (110a-b) with the primary resonator (108).

The combination of a primary resonator (108) and one or more parasitic resonator element (110) may be integrated and mounted into phone housings in a number of ways. In one embodiment, because the primary antenna (108) may differ very little, if at all, from a conventional low-frequency antenna design, for example, a helical coil antenna design, standard well known mounting techniques may be used to mount antenna (108), as for example, on, within, and/or outside a phone housing. It is identified that, when mounted within or a combination of within and outside a phone housing, a primary resonator (108) as described herein may be more closely positioned within the phone housing next to a parasitic element (110).

Because a parasitic resonator element (110), as described herein, requires relatively very little volume, one or more parasitic resonator element (110) may be used within a phone housing without adversely impacting the circuit design and ergonomics of the phone. In one embodiment, one or more parasitic resonator element (110) may be deposited or attached internal to a phone housing by simple mechanical attachment. In an embodiment where the resonator element is mounted on a substrate, the substrate may be attached to the phone housing. It is identified that a parasitic resonator element (110) may be designed to conform to the shape of a phone housing and, thus, may comprise a flat planar geometry, a curved geometry, or other geometry of the phone housing. With variations in geometry, it is understood that different parasitic resonator element (110) conductor spacing, turns, etc., may be required to achieve an equivalent coupling to a primary resonator (108), with such variations in geometry being achievable by those skilled in the art. In one embodiment, one or more parasitic resonator element (110) may be mounted into a thin film, and in mold decorating (IMD) techniques may be used to integrate the thin film into a phone housing. IMD techniques are known to those skilled in the art, and may be used to integrate spiral as well as other antenna geometries into a plastic phone housing. A variety of techniques known to those skilled in the art can be used to provide electrical connections to a parasitic resonator element (110), for example, a pogo pin connection, a flex cable connection, etc. Many other methods of mounting and coupling to parasitic resonator elements are also within the scope of the present invention and would be understood by those skilled in the art.

The embodiments presented herein are not to be construed as limiting the scope of the invention. Although technologies and phone sizes may change with time, other frequencies that may considered to be “low” may come within the scope of the invention described herein. Thus, although communication devices operating at certain frequencies are discussed, the principles described herein are applicable to other frequencies. For example, frequencies at which phone (102) operates that are lower or higher than 1 GHz are envisioned and are within the scope of the present invention. Furthermore, although parasitic resonator elements is (108) are described herein as comprising specific geometries, other geometries are also envisioned. For example, in one embodiment, parasitic element (108) may comprise a capacitively coupled dipole antenna geometry as is disclosed in commonly assigned patent application Ser. No. #10/1375,423, filed on Feb. 27, 2003, which is incorporated herein by reference.

Thus, it will be recognized that the preceding description embodies one or more invention that may be practiced in other specific forms without departing from the spirit and essential characteristics of the disclosure, and that the invention is not to be limited by the foregoing illustrative details, but rather is to be defined by the appended claims.

What is claimed is:

1. A multi-frequency communications device, comprising:
a primary resonator, the primary resonator for enabling a frequency at which the communications device operates; and
a parasitic resonator element, wherein when excited the parasitic resonator element couples to the primary resonator to alter the frequency at which the communications device operates.

2. The communications device of claim 1, wherein the primary resonator comprises a low frequency antenna.

3. The communications device of claim 2, wherein the low frequency is within the 300 to 500 MHz frequency band.

4. The communications device of claim 2, wherein the primary resonator comprises a coil antenna.

5. The communications device of claim 1, wherein the primary resonator radiates a dipole type radiation pattern.

6. The communications device of claim 1, wherein the parasitic resonator radiates a quadruple type radiation pattern.

7. The communications device of claim 1, wherein the parasitic resonator element comprises a spiral geometry.

8. The communications device of claim 1, wherein the parasitic resonator element comprises a capacitively coupled dipole antenna.

9. The communications device of claim 1, wherein the communications device comprises a housing, and wherein the parasitic resonator element is disposed within or on the housing.

10. The communications device of claim 2, wherein the communications device operates at two or more low frequencies.

11. The communications device of claim 1, wherein the primary resonator comprises a stub antenna.

12. The communications device of claim 1, wherein the communications device comprises a phone.

13. The communications device of claim 1, wherein the communications device comprises a PDA.

14. A phone for operating at a frequency, comprising:
a plurality of resonator elements, wherein when one resonator element is excited the one resonator element couples with another resonator element to effectuate the operating frequency at which the phone operates.

15. The phone of claim 14, wherein only one of the plurality of resonator elements radiates a dipole radiation pattern.

16. The phone of claim 15, wherein at least one other of the plurality of resonator elements radiates a quadruple radiation pattern.

17. The phone of claim 14, wherein at least one of the plurality of resonator elements comprises a parasitic resonator.

18. The phone of claim 17, wherein the phone comprises a multi frequency low band phone, wherein the phone comprises a housing, and wherein at least one of the plurality of resonator elements is coupled to the housing.

19. The phone of claim 18, wherein the phone comprises only one stub antenna.

20. The phone of claim 14, wherein the frequency is in a range below 1 GHz.

21. A resonator for use with a primary antenna of a phone, comprising:
a parasitic element, wherein when excited the parasitic element couples to the primary antenna to change an operating characteristic of the primary antenna.

22. The resonator of claim 21, wherein when excited the parasitic element exhibits a quadruple type of radiation pattern.

23. The resonator of claim 21, wherein the primary antenna comprises a stub type antenna.

24. A resonator for use with a primary antenna of a phone, comprising: parasitic coupling means for parasitically coupling to the primary antenna so as to change an operating characteristic of the primary antenna.

25. A method of using a parasitic resonator with a communications device, comprising the steps of:
providing a primary resonator that exhibits a radiation pattern when excited;
providing a parasitic resonator that comprises a radiation pattern when excited;
positioning the parasitic resonator such that it electronically couples to the primary resonator so as to change an operating characteristic of the primary resonator.

26. The method of claim 25, wherein the communications device comprises a phone.

27. The method of claim 25, wherein the communications device comprises a PDA type device.

28. The method of claim 25, wherein the primary resonator comprises a stub type antenna, and wherein the communications device comprises only one stub type antenna.

29. The method of claim 25, wherein the operating characteristic comprises an operating frequency that is less than 1 GHz.
